(19) United States
(12) Patent Application Publication
(10) Pub. No.: US 2026/0256552 A1
(43) Pub. Date: Sep. 3, 2026

(54) L-SHAPED DENTAL POST FOR ROOT CANAL TREATMENT

(71) Applicant: KIANOR SHAHMOHAMMADI, Palm Desert, CA (US)

(72) Inventor: KIANOR SHAHMOHAMMADI, Palm Desert, CA (US)

(21) Appl. No.: 19/531,230

(22) Filed: Feb. 5, 2026

Related U.S. Application Data
(60) Provisional application No. 63/764,588, filed on Feb. 28, 2025.

(51) Int. Cl. A61C 8/00

(52) U.S. Cl. CPC A61C 8/0037

(57) ABSTRACT

Embodiments of the present disclosure disclose a dental post for use in root canal treatment. The dental post comprises a vertical portion configured for insertion into a root canal of a tooth, the vertical portion having a length extending from a coronal end to an apical end. The dental post further comprises a horizontal portion extending laterally from the coronal end of the vertical portion to form an L-shaped configuration. The horizontal portion is configured to lock buildup material beneath the horizontal portion when the dental post is inserted into the root canal, thereby reducing lateral movement of the buildup material and enhancing retention of the buildup material during crown restoration. The dental post may be constructed from biocompatible materials and may include a micro-textured surface on the vertical portion to enhance mechanical retention within the root canal.

### CROSS-REFERENCE TO RELATED APPLICATIONS

This application claims priority to U.S. Provisional Application No. 63/764,588 , titled “ A Dental Post for Reinforcing and Supporting Restorations Over Endodontically Treated Teeth”, filed Feb. 28, 2025, which is hereby incorporated by reference in its entirety.

### FIELD OF INVENTION

The present disclosure relates to dental restorations, and more particularly to an L-shaped dental post for reinforcing and supporting restorations over endodontically treated teeth during root canal treatment.

### BACKGROUND

With poor dietary habits, inadequate oral hygiene, and a rise in oral diseases, dental problems are increasingly prevalent. Conditions such as deep tooth decay, traumatic injuries, and infections of the tooth pulp are among the common issues requiring dental care. If left untreated, these problems can lead to complications, including pain, tooth loss, and systemic health concerns. As a result, treatments such as root canal treatment (RCT) have become valuable for preserving dental health and extending the life of natural teeth.

Root canal treatment is a procedure for saving severely decayed or infected teeth. During RCT, the pulp of the tooth is removed to eliminate infection and prevent further damage. However, once the pulp is removed, the remaining tooth structure may be weakened and less able to withstand the forces of biting and chewing. This challenge becomes more pronounced when the tooth structure is compromised. In such cases, the tooth may not be able to bear daily stresses, increasing the risk of failure in the restoration and potentially requiring further interventions.

To restore functionality and preserve the tooth, additional structural reinforcement, such as the placement of a post within the root canal, may be employed. After cleaning the root canal, a post can be inserted to provide structural support for the tooth. The post helps anchor the filling material within the root canal, preventing displacement and providing a foundation for the final crown or other restorative material. Without a properly placed post to anchor the tooth and support the buildup material, the likelihood of restoration failure or loosening may be higher.

Various approaches to dental posts and crown restoration have been developed. Some methods involve the use of fiberglass pins installed within prepared root canals, with stump components modeled and fabricated using CAD/CAM systems and ceramic materials. These approaches may include forming intra-root and supra-root portions to support artificial crowns. However, conventional posts are often elongated cylindrical structures that provide support at the center of teeth and may not anchor the restoration as effectively as desired, potentially leading to loosening and displacement over time under normal chewing and biting forces. While angled abutments exist for use with dental implants, conventional posts designed for insertion into natural teeth following root canal treatment are typically straight. The L-shaped dental post of the present disclosure is designed for insertion into natural teeth, providing an angled configuration that offers improved retention compared to conventional straight posts.

Various approaches to dental posts and crown restoration have been developed. Some methods involve the use of fiberglass pins installed within prepared root canals, with stump components modeled and fabricated using CAD/CAM systems and ceramic materials. These approaches may include forming intra-root and supra-root portions to support artificial crowns. However, conventional posts are often elongated cylindrical structures that provide support at the center of teeth and may not anchor the restoration as effectively as desired, potentially leading to loosening and displacement over time under normal chewing and biting forces. While angled abutments exist for use with dental implants, conventional posts designed for insertion into natural teeth following root canal treatment are typically straight. The L-shaped dental post of the present disclosure is designed for insertion into natural teeth, providing an angled configuration that offers improved retention compared to conventional straight posts.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to a first aspect of the invention, a dental post for use in root canal treatment is provided. The dental post comprising: a vertical portion configured for insertion into a root canal of a tooth, the vertical portion having a length extending from a coronal end to an apical end; and a horizontal portion extending laterally from the coronal end of the vertical portion to form an L-shaped configuration, wherein the horizontal portion is configured to lock buildup material beneath the horizontal portion when the dental post is inserted into the root canal, thereby reducing lateral movement of the buildup material and enhancing retention of the buildup material during crown restoration.

In one embodiment of the invention, the vertical portion comprises a micro-textured surface configured to enhance mechanical retention within the root canal.

In one embodiment of the invention, the micro-textured surface comprises horizontal ridges or grooves extending along the length of the vertical portion.

In one embodiment of the invention, the vertical portion comprises a tapered tip at the apical end configured to facilitate insertion of the dental post into the root canal.

In one embodiment of the invention, the dental post is constructed from a biocompatible material selected from the group consisting of stainless steel, titanium, fiber-reinforced composites, resin-based composites, plastics, and ceramics.

In one embodiment of the invention, the horizontal portion comprises a hollow core configured to reduce material volume while maintaining structural integrity.

In one embodiment of the invention, the hollow core provides space for bonding agents to enhance adhesion between the dental post and the root canal.

In one embodiment of the invention, the horizontal portion has a cross-sectional shape selected from the group consisting of circular, oval, and square.

In one embodiment of the invention, the length of the vertical portion is adjustable by trimming to accommodate different root canal depths.

In one embodiment of the invention, the horizontal portion is configured to create a ferrule effect by locking the buildup material beneath the horizontal portion, thereby improving the mechanical bond between the buildup material and a crown placed over the dental post.

In one embodiment of the invention, the vertical portion exhibits a tapered profile with a diameter that narrows from the coronal end toward the apical end.

According to a second aspect of the invention, a method for restoring a tooth following root canal treatment is provided. The method comprising: preparing a root canal of the tooth by cleaning and shaping the root canal; selecting a dental post having an L-shaped configuration with a vertical portion and a horizontal portion extending laterally from the vertical portion; inserting the vertical portion of the dental post into the prepared root canal such that the horizontal portion extends outward from the root canal; cementing the dental post within the root canal; applying buildup material around the horizontal portion of the dental post, wherein the horizontal portion locks the buildup material beneath the horizontal portion to prevent lateral displacement; and placing a crown over the buildup material to restore the tooth.

In one embodiment of the invention, the method further comprising applying a bonding agent to the dental post and the root canal prior to cementing the dental post.

In one embodiment of the invention, the bonding agent fills gaps between the dental post and the canal walls of the root canal.

In one embodiment of the invention, the method further comprising adjusting a length of the vertical portion by trimming prior to inserting the dental post into the root canal.

In one embodiment of the invention, the horizontal portion creates a ferrule effect by locking the buildup material beneath the horizontal portion, thereby distributing occlusal forces across the dental post and reducing the risk of root fracture.

According to a third aspect of the invention, a dental post system for root canal treatment is provided. The dental post system comprising: a dental post having an L-shaped configuration including a vertical portion with a micro-textured outer surface and a horizontal portion extending laterally from an upper end of the vertical portion; wherein the vertical portion is configured for insertion into a root canal and the horizontal portion is configured to extend outward from the root canal to create a mechanical interlock with buildup material applied around the horizontal portion; and wherein the L-shaped configuration provides a ferrule effect by locking the buildup material under the horizontal portion to distribute occlusal forces and reduce risk of post displacement.

In one embodiment of the invention, the micro-textured outer surface comprises horizontal ridges extending circumferentially around the vertical portion to enhance bonding with root canal sealer and post-cement.

In one embodiment of the invention, the vertical portion comprises a tapered profile with a diameter that narrows from the upper end toward an apical end to facilitate insertion into the root canal and reduce the risk of root perforation.

In one embodiment of the invention, the horizontal portion comprises a hollow core that reduces material volume while maintaining structural integrity and provides space for additional bonding agents to enhance adhesion.

In the context of this specification, the term "vertical portion" or “vertical arm” refers to the longer vertical portion of the L-shaped dental post, which may also be referred to as a dowel or stump portion. The vertical portion extends from a coronal end to an apical end, where the coronal end refers to the upper end of the vertical portion proximate to the horizontal portion, and the apical end refers to the lower end or bottom end of the vertical portion.

In the context of this specification, the term "horizontal portion" or “horizontal arm” refers to the shorter horizontal portion of the L-shaped dental post, which may also be referred to as a horizontal arm or lateral extended head region. The horizontal portion extends laterally from the coronal end of the vertical portion to form the L-shaped configuration.

In the context of this specification, the term "buildup material" refers to restorative material applied around the horizontal portion of the dental post to create a foundation for crown placement. The buildup material may include composite resins, amalgam, or other suitable dental restorative materials.

In the context of this specification, the term "ferrule effect" refers to the mechanical advantage created when the horizontal portion of the L-shaped dental post locks the buildup material beneath it, thereby improving the bond between the core material, crown, and dental post.

In the context of this specification, the term "ferrule effect" refers to the mechanical advantage created when the horizontal portion of the L-shaped dental post locks the buildup material beneath it, thereby improving the bond between the core material, crown, and dental post. The ferrule effect is reestablished in part because the mechanical locking of the buildup material beneath the horizontal portion results in less or no shrinkage of the core buildup materials compared to conventional posts, in addition to the biophysical principles of force distribution and mechanical interlocking.

In the context of this specification, the term "micro-textured surface" refers to a surface that has been treated to create microscopic surface irregularities that enhance mechanical retention. Micro-textured surfaces may be created through various surface treatments including, but not limited to, sandblasting, chemical etching, silanization, laser marking, or micro-roughening.

### BRIEF DESCRIPTION OF DRAWINGS

The accompanying drawings illustrate the best mode for carrying out the invention as presently contemplated and set forth hereinafter. The present invention may be more clearly understood from a consideration of the following detailed description of the preferred embodiments taken in conjunction with the accompanying drawings, wherein like reference letters and numerals indicate the corresponding parts in various figures in the accompanying drawings, and in which:

FIG. 1 illustrates a front view of an L-shaped dental post, according to aspects of the present disclosure.

FIG. 2A illustrates a top view of the L-shaped dental post of FIG. 1, according to an embodiment.

FIG. 2B illustrates a perspective view of the L-shaped dental post of FIG. 1, according to aspects of the present disclosure.

FIG. 3 illustrates a cross-sectional view of a tooth with the L-shaped dental post installed, according to an embodiment.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

Embodiments of the present invention disclose a dental post for use in root canal treatment. The dental post comprises a vertical portion configured for insertion into a root canal of a tooth, the vertical portion having a length extending from a coronal end to an apical end. The dental post further comprises a horizontal portion extending laterally from the coronal end of the vertical portion to form an L-shaped configuration. The horizontal portion is configured to lock buildup material beneath the horizontal portion when the dental post is inserted into the root canal, thereby reducing lateral movement of the buildup material and enhancing retention of the buildup material during crown restoration.

The dental post for use in root canal treatment may include a body having a non-cylindrical configuration. In some cases, the body has a concave or hourglass-shaped design along the length of the body. The hourglass-shaped design provides enhanced retention by increasing surface area contact with the canal walls of a root canal. The body may include dual tapered ends positioned at both ends of the length of the body. The tapered ends facilitate easier insertion of the dental post into the root canal.

An outer surface of the dental post may be designed with micro-textured patterns or grooves. The micro-textured patterns enhance mechanical retention within the root canal. The micro-textured patterns promote better bonding with root canal sealer and post-cement, minimizing the likelihood of post-loosening. In some cases, the design includes curvilinear or zigzag patterns along the length of the body to better adapt to root canal anatomy.

The diameter of the dental post may vary along the length of the body to match the anatomical characteristics of the root canal. In some cases, the dental post has a wider diameter near a coronal portion and a narrower diameter in an apical portion. The wider diameter near the coronal portion helps support a crown, while the narrower diameter in the apical portion reduces the risk of perforation and trauma to the root during placement.

The dental post may include a hollow core. The hollow core reduces material volume, making the dental post lighter and easier to handle while maintaining structural integrity. The hollow core also provides space for additional bonding agents to enhance adhesion between the dental post and the root canal.

The dental post may be constructed from biocompatible materials. Biocompatible material options include titanium, stainless steel, fiber-reinforced composites, resin-based composites, plastics, and ceramics. These materials ensure sufficient strength to withstand mechanical forces, resist corrosion, and maintain long-term stability within the root canal. The L-shaped dental post may also be referred to as a Ferrule Post due to its ability to create a ferrule effect during restoration.

The shorter horizontal portion of the L-shaped dental post may have a circular, oval, or square cross-sectional shape. Each cross-sectional shape offers distinct advantages for different clinical scenarios. The circular shape provides uniform contact for bonding with the surrounding material. The oval shape increases contact area with surrounding buildup material, which is beneficial for irregular or larger root canals. The square shape provides enhanced mechanical retention, as sharp edges create a better mechanical lock with surrounding material.

The dental post has an L-shaped configuration with a longer vertical portion and a shorter horizontal portion. The shorter horizontal portion may also be referred to as a lateral extended head region. The lateral extended head region allows material to lock under the inverted head and facilitates easy crowning of the tooth. The length of the longer vertical portion (dowel) is adjustable, allowing for customization to different root canal anatomies. The shorter horizontal portion of the L-shaped dental post may have a circular, oval, or square cross-sectional shape. Each cross-sectional shape offers distinct advantages for different clinical scenarios. The circular shape provides uniform contact for bonding with the surrounding material. The oval shape increases contact area with surrounding buildup material, which is beneficial for irregular or larger root canals. The square shape provides enhanced mechanical retention, as sharp edges create a better mechanical lock with surrounding material.

The L-shaped dental post may be configured with various dimensional relationships between the longer vertical portion and the shorter horizontal portion. In some cases, the longer vertical portion has a length that is approximately two to four times the length of the shorter horizontal portion. The length of the longer vertical portion may range from approximately 5 millimeters to 15 millimeters, depending on the tooth type and root canal depth. The shorter horizontal portion may have a length ranging from approximately 2 millimeters to 5 millimeters. The diameter of the longer vertical portion may be selected to match standard endodontic drill sizes, such as sizes ranging from 0.5 millimeters to 2.0 millimeters. These dimensional ranges are provided as examples and may be adjusted based on specific clinical requirements and patient anatomy.

The length at both ends of the L-shaped dental post may be adjustable. Adjustment can be performed by trimming the dental post at the longer portion extending into the root or at the shorter portion extending outward to lock the buildup material. The nonlinear L-shaped dental post may be further adjusted by trimming or contouring to ensure a fit within the root canal before insertion.

In some cases, the shorter horizontal portion of the L-shaped dental post is designed to avoid adjustment with a bur. Unlike the longer vertical portion, which may be trimmed to accommodate different root canal depths, the shorter portion is intended to remain intact to maximize the locking effect with the buildup material. This design consideration helps preserve the structural integrity and retention properties of the shorter horizontal portion.

In some cases, the shorter horizontal portion of the L-shaped dental post is designed to avoid adjustment with a bur. Unlike the longer vertical portion, which may be trimmed to accommodate different root canal depths, the shorter portion is intended to remain intact to maximize the locking effect with the buildup material. This design consideration helps preserve the structural integrity and retention properties of the shorter horizontal portion.

The dental post may be fabricated using 3D printing methods such as stereolithography (SLA) or selective laser sintering (SLS). These methods build the dental post layer by layer from a chosen material, allowing for high precision and the creation of complex, nonlinear shapes. In some cases, the dental post is created by pouring material into a mold designed to produce a nonlinear shape. Mold casting may involve heat-curing or light-curing techniques, depending on the material. The dental post may also be milled from a solid block of material using a computer numerically controlled (CNC) machine, allowing for precise shaping of nonlinear geometry.

The dental post may undergo various surface treatments to enhance retention and bonding properties. In some cases, the outer surface of the vertical portion may be sandblasted to create a roughened surface that enhances mechanical retention within the root canal. Chemical etching may be applied to increase surface area and improve bonding with dental cements and adhesives. Silanization treatment may be applied to the dental post to enhance chemical bonding between the dental post and resin-based cements or composite materials. In some cases, the dental post may include color marking for identification of post size, post type, or material composition. These surface treatments may be used individually or in combination depending on clinical requirements and material compatibility.After fabrication, the dental post may undergo post-processing to enhance surface properties. Post-processing may include surface texturing, etching, and polishing. The outer surface of the dental post may be treated with etching, micro-roughening, or laser marking to increase surface area and improve mechanical retention within the root canal. The dental post may also be polished to ensure smoothness, reducing friction during insertion and minimizing the risk of root damage. The L-shaped dental post is designed to match different drill sizes depending on root canal treatment requirements. In some cases, the L-shaped dental post may be prefabricated in standard sizes to match different drill sizes, providing an off-the-shelf solution in addition to custom fabrication options.

Quality control measures may be employed to verify the proper fit of the L-shaped dental post before final cementation. The dental post may be trial-fitted into the prepared root canal to assess the fit and adaptation to the canal walls. Radiographic imaging, such as periapical radiographs, may be used to verify the position and depth of the dental post within the root canal. The fit of the shorter horizontal portion may be assessed to ensure adequate clearance for buildup material application. Any necessary adjustments to the longer vertical portion may be made by trimming before final cementation. Retention testing may be performed after cementation to verify the bond strength between the dental post and the root canal.

The installation of the dental post involves preparing the root canal before insertion. The root canal is cleaned and shaped to remove infected or necrotic tissue and debris. Specialized endodontic instruments are used to shape the canal to accommodate the dental post. The canal is dried thoroughly to remove remaining moisture, ensuring proper bonding of the dental post.

A nonlinear L-shaped dental post designed to match the specific anatomy of a root canal may be selected based on a pre-treatment evaluation. The pre-treatment evaluation may include imaging such as 3D scans or CBCT to assess the root canal size, curvature, and irregularities. In some cases, imaging technology such as 2D, 3D, or CBCT may be used to map the anatomy and length of the root canal, creating the required post space before selecting the final dental post.

The L-shaped dental post is carefully inserted into the root canal. The dental post may be gently rotated or moved slightly during insertion to ensure optimal placement within the canal anatomy. Due to its design, the dental post naturally adapts to the irregularities of the canal, providing a snug and secure fit. The nonlinear features of the dental post allow the dental post to adapt to the canal anatomy, reducing the risk of dislodgement or excessive force being placed on the tooth.

Following placement of the dental post, a bonding agent or adhesive is applied to the dental post and the prepared root canal. The application of a bonding agent may be particularly relevant for fiber post versions of the L-shaped dental post. The adhesive fills gaps between the dental post and canal walls. The bonding agent is cured, and the dental post is further cemented or luted into place using dental cement specifically designed for root canal posts. The cement is applied to ensure uniform coverage and a tight seal around the dental post.

The surface of the dental post closely matches the contours of the canal, ensuring minimal gaps between the dental post and surrounding tooth structure. The close fit enhances bonding between the dental post and the canal, preventing lateral movement and ensuring that the dental post remains securely in place during restoration.

The L-shaped configuration of the dental post reduces the risk of rotation or displacement within the root canal. The non-cylindrical design and surface texturing work together to prevent rotational movement that may occur with conventional cylindrical posts. The secure anchoring ensures the dental post remains stable under daily functional loads, including chewing and biting forces.

Buildup material is applied around the shorter horizontal portion of the L-shaped dental post. The buildup material may be composite resins or amalgam. The buildup material is shaped to conform to both the root canal and the dental post, creating a foundation for final crown placement. The L-shape of the dental post prevents displacement of the buildup material, ensuring the buildup material remains stable during healing and under chewing forces.

The L-shaped dental post is particularly beneficial for cases involving extensively damaged or weakened root canals. In cases where a significant portion of the coronal tooth structure is missing, the L-shaped design ensures that the dowel and buildup material remain securely anchored despite chewing or biting stresses. The mechanical interlock provided by the L-shaped configuration offers enhanced support compared to conventional straight posts in compromised tooth structures.

The L-shaped dental post may be used in various clinical scenarios involving different tooth types. For anterior teeth such as incisors and canines, which typically have single root canals, the L-shaped dental post provides enhanced retention in cases where significant coronal tooth structure is missing. For premolars, which may have one or two root canals, the L-shaped dental post may be placed in the primary canal to provide support for the restoration. For molars with multiple root canals, the L-shaped dental post may be placed in the largest or most accessible canal, with additional retention provided by the remaining tooth structure or supplementary posts in other canals. The L-shaped configuration is particularly beneficial in cases involving endodontically treated teeth with minimal remaining coronal structure, where conventional straight posts may not provide adequate retention.

Following application of the buildup material, a permanent crown is placed over the shaped buildup material to restore the tooth's functionality, integrity, and appearance. The crown placement completes the restoration process, with the L-shaped dental post providing enhanced retention, stability, and support throughout the restored tooth structure.

The L-shaped dental post enables smooth integration with surrounding buildup material, ensuring a solid foundation for the final crown and enhancing the tooth's overall functional and aesthetic restoration.

The L-shaped design provides a ferrule effect by locking the buildup material under the horizontal arm. In a dental preparation, extending a preparation apically creates a ferrule. The L-shaped design binds or locks the preparation material under the horizontal arm, thereby creating a ferrule on the prepared tooth upon which the crown can be placed. The ferrule effect is reestablished in part because the mechanical locking of the buildup material beneath the horizontal portion results in less or no shrinkage of the core buildup materials compared to conventional posts, in addition to the biophysical principles of force distribution and mechanical interlocking. In a dental preparation, extending a preparation apically creates a ferrule. The L-shaped design binds or locks the preparation material under the horizontal arm, thereby creating a ferrule on the prepared tooth upon which the crown can be placed. The ferrule effect improves the mechanical and chemical bond between the core material, crown, and dental post, ensuring longer retention. The L-shaped design helps distribute occlusal forces more evenly across the root and dental post, reducing the risk of post debonding or root failure. Without a ferrule, forces may concentrate at an apical end of the dental post, leading to potential vertical root fractures. The L-shaped design also reduces lateral pressure that could otherwise break off teeth, and helps prevent posts from coming loose. The L-shaped post provides better stress distribution, particularly in cases where a significant portion of the coronal tooth structure is missing.

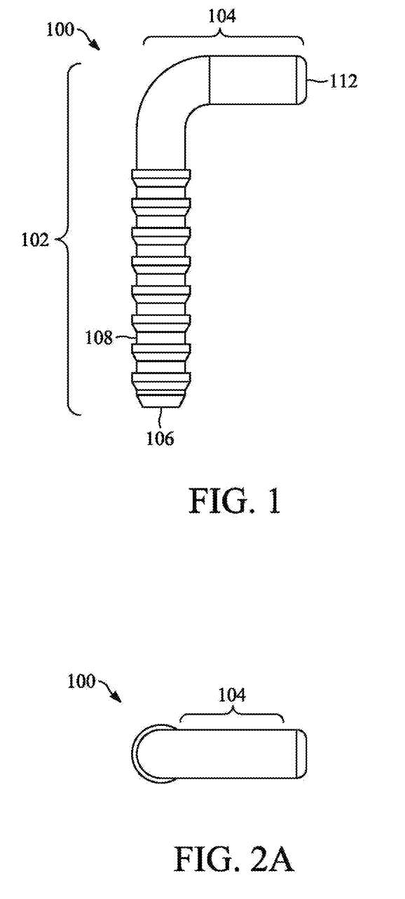

Referring to FIG. 1, a front view of the L-shaped dental post 100 is shown. The L-shaped dental post 100 includes a longer vertical portion 102 and a shorter horizontal arm 104. The longer vertical portion 102 features a tapered design that narrows toward the bottom end of the longer vertical portion 102. The longer vertical portion 102 includes horizontal ridges or grooves 108 extending along the length of the longer vertical portion 102. The horizontal ridges or grooves 108 create a threaded or serrated appearance on an outer surface of the longer vertical portion 102. The threaded or serrated appearance enhances mechanical retention when the L-shaped dental post 100 is inserted into a root canal 202.

With continued reference to FIG. 1, the longer vertical portion 102 terminates at a lower end in a tapered tip 106. The tapered tip 106 facilitates insertion of the L-shaped dental post 100 into a prepared root canal space. The tapered configuration of the tapered tip 106 allows the L-shaped dental post 100 to be guided into the root canal with reduced resistance during placement.

At an upper end of the longer vertical portion 102, the shorter horizontal arm 104 extends laterally at approximately ninety degrees from the longer vertical portion 102. The shorter horizontal arm 104 forms the characteristic L-shape configuration of the L-shaped dental post 100. The shorter horizontal arm 104 appears smooth and cylindrical with a rounded end cap 112. The shorter horizontal arm 104 is positioned to extend outward from the root canal when the L-shaped dental post 100 is installed, providing a surface for locking buildup material in place during subsequent restoration procedures.

During installation, the shorter horizontal portion of the L-shaped dental post may be oriented in various directions depending on the clinical situation and tooth position. In some cases, the horizontal portion is oriented toward the buccal surface of the tooth. In other cases, the horizontal portion may be oriented toward the lingual, mesial, or distal surfaces. For anterior teeth such as incisors and canines, the horizontal portion may be oriented toward the lingual surface to avoid interference with aesthetics. For posterior teeth such as premolars and molars, the horizontal portion may be oriented based on the available space and occlusal considerations. The orientation of the horizontal portion may also be selected to maximize contact with surrounding buildup material and to avoid interference with adjacent teeth or restorations.

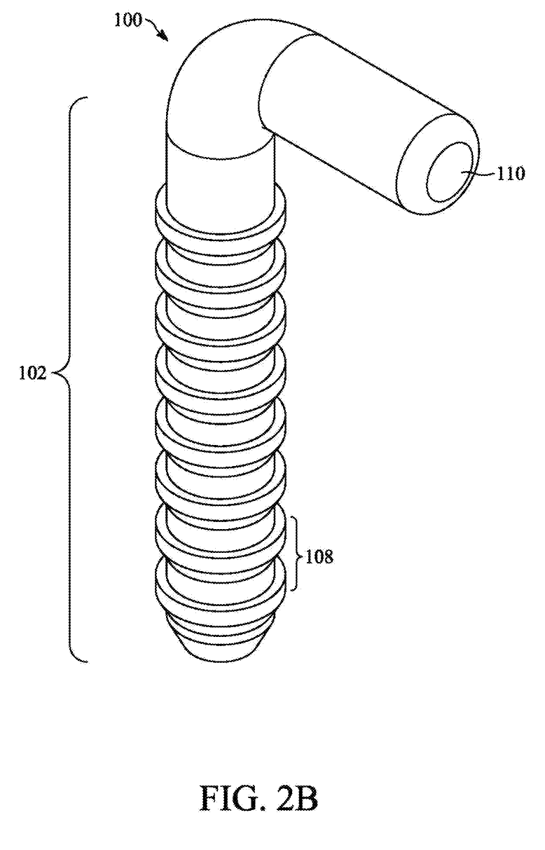

Referring to FIG. 2A, a top view of the L-shaped dental post 100 is shown. From the top view perspective, the horizontal arm 104 of the L-shaped dental post 100 appears as an elongated oval or capsule shape with rounded ends. The elongated oval configuration provides a smooth contour along the extended head region of the horizontal arm 104.

The extended head region is designed to lock the buildup material in place during dental restoration procedures. The smooth contour of the extended head region allows the buildup material to conform around the horizontal arm 104 without creating voids or gaps. The capsule shape of the horizontal arm 104, when viewed from above, demonstrates the lateral extent of the extended head region that protrudes outward from the longer vertical portion 102.

The rounded ends of the horizontal arm 104 reduce stress concentration points where the buildup material contacts the L-shaped dental post 100. The elongated oval shape provides a stable foundation for crown placement by distributing forces across a broader surface area. The smooth surface of the extended head region facilitates integration with surrounding buildup material, promoting a secure bond between the L-shaped dental post 100 and the restoration.

Referring to FIG. 2B, a perspective view of the L-shaped dental post 100 is shown in a three-dimensional representation. The perspective view illustrates the spatial relationship between the two main structural components of the L-shaped dental post 100. The longer vertical portion 102 of the L-shaped dental post 100 features a series of horizontally oriented ridges or grooves 108 that extend along the entire length of the longer vertical portion 102. The horizontally oriented ridges or grooves 108 create a ribbed or threaded appearance on the outer surface of the longer vertical portion 102. The circumferential ridges form a micro-textured surface pattern that enhances mechanical retention when the L-shaped dental post 100 is inserted into a root canal.

With continued reference to FIG. 2B, the longer vertical portion 102 exhibits a slightly tapered profile. The diameter of the longer vertical portion 102 narrows toward the lower end of the longer vertical portion 102. The tapered profile facilitates insertion of the L-shaped dental post 100 into a root canal space by reducing resistance during placement.

At an upper terminus of the longer vertical portion 102, the L-shaped dental post 100 transitions into the shorter horizontal arm 104. The shorter horizontal arm 104 extends laterally at approximately ninety degrees from the longer vertical portion 102, forming the characteristic L-shape configuration. The shorter horizontal arm 104 appears as a smooth cylindrical tube. A hollow core 110 is visible at an open end of the shorter horizontal arm 104. The hollow core 110 reduces the material volume of the L-shaped dental post 100 while maintaining the structural integrity of the shorter horizontal arm 104. The hollow nature of the shorter horizontal arm 104 provides an internal channel that may accommodate additional bonding agents to enhance adhesion.

As further shown in FIG. 2B, the perspective view demonstrates how the L-shaped design creates an inverted L configuration when the L-shaped dental post 100 is inserted into a tooth. The longer vertical portion 102 extends downward into the root canal, anchoring the L-shaped dental post 100 within the root structure. The shorter horizontal arm 104 is positioned above the root canal opening, extending laterally across a coronal portion of the tooth. The inverted L configuration allows buildup material to lock under the shorter horizontal arm 104, preventing lateral displacement of the buildup material during subsequent crown restoration procedures. The spatial arrangement of the longer vertical portion 102 and the shorter horizontal arm 104 provides a mechanical interlock that resists forces applied during chewing and biting.

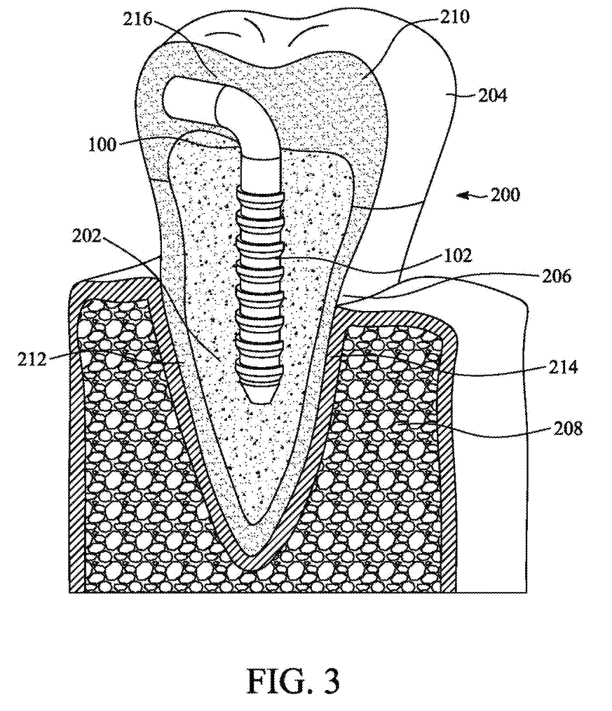

Referring to FIG. 3, a cross-sectional view of a tooth 200 that has undergone root canal treatment with the L-shaped dental post 100 installed is shown. The cross-sectional view illustrates the L-shaped dental post 100 in a functional position within the tooth 200 structure following completion of root canal treatment procedures.

The cross-sectional view depicts complete dental anatomy, including a visible crown portion 204 of the tooth 200 at an upper region of the image. Surrounding gum tissue 206 is shown adjacent to the crown portion 204, encircling the tooth 200 at a gingival margin where the crown portion 204 meets underlying structures. An underlying bone structure is depicted below the gum tissue 206 with a circular pattern representing cancellous bone. The alveolar bone 208 surrounds and supports the root of the tooth 200 within an alveolar socket.

With continued reference to FIG. 3, the L-shaped dental post 100 is visible extending vertically through the center of the tooth 200. The threaded or ridged elongated portion of the L-shaped dental post 100 is inserted into a root canal 202. The longer vertical portion 102 of the L-shaped dental post 100 extends from a root apex upward through the prepared root canal 202. A series of horizontal grooves or threads 108 are visible along the length of the longer vertical portion 102. The horizontal grooves or threads 108 enhance the mechanical retention of the L-shaped dental post 100 within the root canal 202 by increasing surface area contact with canal walls.

The shorter horizontal arm 104 of the L-shaped dental post 100 extends laterally at the upper end of the longer vertical portion 102. The shorter horizontal arm 104 creates the characteristic L-shape configuration when viewed in cross-section. The shorter horizontal arm 104 is positioned above the root canal 202 opening and extends outward across a coronal region of the tooth 200.

As further shown in FIG. 3, the tooth 200 structure surrounding the L-shaped dental post 100 includes a dentin layer 210 depicted with a stippled texture pattern. The dentin layer 210 forms the bulk of the tooth 200 structure and surrounds the root canal 202, where the longer vertical portion 102 of the L-shaped dental post 100 is anchored. An outer root surface is depicted with diagonal hatching representing a cementum 212 and a periodontal ligament space 214. The cementum 212 covers the external surface of the root, and the periodontal ligament space 214 separates the root from the surrounding alveolar bone 208.

The root of the tooth 200 is shown embedded within the alveolar bone 208. The bone structure is differentiated from the tooth 200 by a distinctive circular cellular pattern that represents the trabecular architecture of the cancellous bone. The alveolar bone 208 provides support and anchorage for the tooth 200 within the jaw.

The cross-sectional view demonstrates how the L-shaped dental post 100 provides structural support and anchoring within the root canal 202. The longer vertical portion 102 extends deep into the root canal 202, securing the L-shaped dental post 100 within the root structure. The threaded surface of the longer vertical portion 102 engages with canal walls and bonding materials to resist displacement forces during function.

The shorter horizontal arm 104 is positioned to lock the buildup material 216 in place. The horizontal arm 104 extends laterally over the crown portion 204 of the tooth 200, creating an inverted L configuration. Buildup material 216 applied around the shorter horizontal arm 104 is mechanically retained beneath the horizontal arm 104. The mechanical retention prevents lateral displacement of the buildup material 216 under occlusal forces applied during chewing and biting.

The L-shaped dental post 100 creates a stable foundation for crown restoration. The longer vertical portion 102 anchored within the root canal 202 transfers occlusal forces from the crown through the L-shaped dental post 100 into the root structure. The shorter horizontal arm 104 distributes forces across the buildup material 216 and provides a ferrule effect that enhances retention of the final crown. The cross-sectional view illustrates how the L-shaped dental post 100, buildup material 216, and root canal 202 structure work together to provide enhanced support and retention for restoration of the tooth 200 following root canal treatment.

In an embodiment of the present invention, a method for using the L-shaped dental post in root canal treatment is now described. The method involves multiple steps including preparing the root canal, selecting and adjusting the dental post, inserting the L-shaped dental post 100, applying bonding agents and cement, applying buildup material, and placing a crown.

In a first step, the root canal is prepared before insertion of the L-shaped dental post. The root canal is cleaned and shaped to remove any infected or necrotic tissue and debris. Specialized endodontic instruments are used to shape the root canal to accommodate the L-shaped dental post. The root canal is dried thoroughly to remove any remaining moisture, ensuring proper bonding of the L-shaped dental post.

In a second step, a nonlinear L-shaped dental post designed to match the specific anatomy of the root canal is selected. The L-shaped dental post is chosen based on a pre-treatment evaluation, which may include imaging such as 3D scans or cone-beam computed tomography (CBCT) to assess the root canal size, curvature, and irregularities. In some cases, imaging technology such as 2D, 3D, or CBCT may be used to map the anatomy and length of the root canal, creating the required post space before selecting the final L-shaped dental post.

In a third step, the L-shaped dental post may be adjusted to ensure a proper fit within the root canal. The nonlinear L-shaped dental post may be trimmed or contoured to ensure a fit within the root canal before insertion. This step ensures the L-shaped dental post follows the natural curves of the root canal without creating gaps or causing excessive pressure on the root walls. The length of the longer vertical portion may be trimmed to accommodate different root canal depths.

In a fourth step, the L-shaped dental post is carefully inserted into the root canal. The L-shaped dental post may be gently rotated or moved slightly during insertion to ensure optimal placement within the canal anatomy. Due to its design, the L-shaped dental post naturally adapts to the irregularities of the root canal, providing a snug and secure fit. The longer vertical portion of the L-shaped dental post is securely anchored within the root, while the shorter horizontal arm 104 extends outward from the root canal.

In a fifth step, a bonding agent or adhesive is applied to the L-shaped dental post and the prepared root canal. The application of the bonding agent may be particularly relevant for fiber post versions of the L-shaped dental post. The adhesive fills gaps between the L-shaped dental post and the canal walls of the root canal. The bonding agent is cured, and the L-shaped dental post is further cemented or luted into place using dental cement specifically designed for root canal posts. The cement is applied to ensure uniform coverage and a tight seal around the L-shaped dental post.

Various types of dental cement may be used to secure the L-shaped dental post within the root canal. Suitable cement types include resin cement, glass ionomer cement, resin-modified glass ionomer cement, and zinc phosphate cement. Resin cement provides strong adhesive bonding and is compatible with fiber-reinforced composite posts. Glass ionomer cement offers fluoride release and chemical bonding to tooth structure. Zinc phosphate cement provides a long clinical history and reliable retention. The selection of cement type may depend on the post material, clinical requirements, and practitioner preference. Dual-cure resin cements may be particularly suitable for the L-shaped dental post as they allow for both light-curing and self-curing mechanisms.

In a sixth step, buildup material is applied around the shorter horizontal arm 104 of the L-shaped dental post. The buildup material may be composite resins or amalgam. The buildup material is shaped to conform to both the root canal and the L-shaped dental post, creating a foundation for final crown placement. The shorter horizontal portion locks the buildup material beneath the horizontal portion, preventing lateral displacement of the buildup material. The mechanical locking of the buildup material 216 beneath the shorter horizontal portion 104 results in less or no shrinkage of the core buildup materials compared to conventional straight posts, contributing to the reestablishment of the ferrule effect. The buildup material is shaped and contoured to prepare the tooth for crown placement.

In a seventh step, a permanent crown is placed over the shaped buildup material to restore the tooth's functionality, integrity, and appearance. The crown placement completes the restoration process. The L-shaped dental post provides enhanced retention, stability, and support throughout the restored tooth structure, ensuring long-term success of the restoration.

A number of implementations have been described. Nevertheless, it will be understood that various modifications may be made without departing from the spirit and scope of the disclosure. Accordingly, other implementations are within the scope of the following claims.

1. A dental post for use in root canal treatment, comprising:
a vertical portion configured for insertion into a root canal of a tooth, the vertical portion having a length extending from a coronal end to an apical end; and
a horizontal portion extending laterally from the coronal end of the vertical portion to form an L-shaped configuration, wherein the horizontal portion is configured to lock a buildup material beneath the horizontal portion when the dental post is inserted into the root canal, thereby reducing lateral movement of the buildup material and enhancing retention of the buildup material during crown restoration.

2. The dental post of claim 1, wherein the vertical portion comprises a sandblasted surface configured to enhance mechanical retention within the root canal.

3. The dental post of claim 2, wherein the vertical portion comprises an etched surface configured to increase surface area and improve bonding with dental cement.

4. The dental post of claim 3, wherein the vertical portion comprises a silanized surface configured to enhance chemical bonding with resin-based cement.

5. The dental post of claim 1, wherein the vertical portion comprises a tapered tip at the apical end configured to facilitate insertion of the dental post into the root canal.

6. The dental post of claim 1, wherein the dental post further comprising color making for identification of at least one of post size, post type, or material composition.

7. The dental post of claim 1, wherein the horizontal portion comprises a hollow core configured to reduce material volume while maintaining structural integrity.

8. The dental post of claim 7, wherein the hollow core provides space for bonding agents to enhance adhesion between the dental post and the root canal.

9. The dental post of claim 1, wherein the horizontal portion has a cross-sectional shape selected from the group consisting of circular, oval, and square.

10. The dental post of claim 1, wherein the length of the vertical portion is adjustable by trimming to accommodate different root canal depths.

11. The dental post of claim 1, wherein the horizontal portion is configured to create a ferrule effect by locking the buildup material beneath the horizontal portion, thereby improving the mechanical bond between the buildup material and a crown placed over the dental post.

12. A method for restoring a tooth following root canal treatment, comprising:
preparing a root canal of the tooth by cleaning and shaping the root canal;
selecting a dental post having an L-shaped configuration with a vertical portion and a horizontal portion extending laterally from the vertical portion;
inserting the vertical portion of the dental post into the prepared root canal such that the horizontal portion extends outward from the root canal;
cementing the dental post within the root canal;
applying buildup material around the horizontal portion of the dental post, wherein the horizontal portion locks the buildup material beneath the horizontal portion to prevent lateral displacement; and
placing a crown over the buildup material to restore the tooth.

13. The method of claim 12, further comprising applying a bonding agent to the dental post and the root canal prior to cementing the dental post.

14. The method of claim 13, wherein the bonding agent fills gaps between the dental post and the canal walls of the root canal.

15. The method of claim 12, further comprising adjusting a length of the vertical portion by trimming prior to inserting the dental post into the root canal.

16. The method of claim 12, wherein the horizontal portion creates a ferrule effect by locking the buildup material beneath the horizontal portion, thereby distributing occlusal forces across the dental post and reducing the risk of root fracture.

17. A dental post system for root canal treatment, comprising:
a dental post having an L-shaped configuration, including a vertical portion with a micro-textured outer surface and a horizontal portion extending laterally from an upper end of the vertical portion;
wherein the vertical portion is configured for insertion into a root canal, and the horizontal portion is configured to extend outward from the root canal to create a mechanical interlock with buildup material applied around the horizontal portion; and
wherein the L-shaped configuration provides a ferrule effect by locking the buildup material under the horizontal portion to distribute occlusal forces and reduce the risk of post displacement.

18. The dental post system of claim 17, wherein the micro-textured outer surface comprises horizontal ridges extending circumferentially around the vertical portion to enhance bonding with root canal sealer and post-cement.

19. The dental post system of claim 18, wherein the vertical portion comprises a tapered profile with a diameter that narrows from the upper end toward an apical end to facilitate insertion into the root canal and reduce the risk of root perforation.

20. The dental post system of claim 17, wherein the horizontal portion comprises a hollow core that reduces material volume while maintaining structural integrity and provides space for additional bonding agents to enhance adhesion.
